(19) United States
(12) Patent Application Publication
(10) Pub. No.: US 2015/0345768 A1
(43) Pub. Date: Dec. 3, 2015

(54) LED LIGHTING FIXTURES

(71) Applicant: AMERICAN BRIGHT LIGHTING, INC., Chino, CA (US)

(72) Inventors: George LEE, Rowland Heights, CA (US); Stanley CHEN, San Gabriel, CA (US); Raymond WANG, Irvine, CA (US); Lawrence WANG, Taichung (TW)

(73) Assignee: AMERICAN BRIGHT LIGHTING, INC., Chino, CA (US)

(21) Appl. No.: 14/727,063

(22) Filed: Jun. 1, 2015

Related U.S. Application Data
(60) Provisional application No. 62/006,429, filed on Jun. 2, 2014.

(51) Int. Cl. F21V 29/70; F21V 23/02; F21V 5/04; F21K 99/00; F21V 23/00

(52) U.S. Cl. CPC F21V 29/70; F21K 9/175; F21K 9/50; F21V 23/002; F21V 5/04; F21V 23/023; F21Y 2101/02

(57) ABSTRACT

LED lighting systems employing plano optics, direct dissipation heat sinks, and linear AC direct current drivers are disclosed. The heat sink is configured to provide thermal management for the LED lights and AC linear current driver circuit elements, as well as to provide a means for holding lenses having diffractive optical elements. The LED lighting systems are compact, energy efficient, and may be used in many conventional incandescent or fluorescent lighting applications. Lenses having diffractive optical elements are designed to redirect light radiated from the LEDs into other directions.

### RELATED APPLICATION INFORMATION

The present application claims priority under 35 U.S.C. Section 119(e) to U.S. Provisional Patent Application Ser. No. 62/006,429 filed Jun. 2, 2014, entitled “LED LIGHTING FIXTURE DESIGN WITH PLANO OPTICS, DIRECT DISSIPATION HEAT SINK AND LINEAR AC DIRECT DRIVE,” the disclosure of which is incorporated herein by reference in its entirety.

### BACKGROUND OF THE INVENTION

1. Field of the Invention

The present invention relates in general to solid state lighting systems. More particularly, the invention is directed to LED lighting systems having integrated heat sinks with lenses having diffractive optical elements.

2. Description of the Related Art

Solid state lighting apparatuses are becoming increasingly more common as they offer higher efficiencies and longer lifetimes as compared to conventional light sources such as incandescent lamps. However, conventional packaging of LED lighting systems may not adequately address the thermal management aspects, as well as emission pattern requirements, for many applications.

Accordingly, a need exists to improve the packaging of LED lighting systems.

### SUMMARY OF THE INVENTION

In the first aspect, a lighting system is disclosed. The lighting system comprises an elongated heat sink, the heat sink having a back surface configured for mounting, the heat sink further comprising an internal cavity running along the length of the heat sink, the inner cavity having a generally flat bottom surface and two walls extending perpendicular from the generally flat bottom surface, each wall having a groove running along the length of the heat sink, each groove spaced equidistant from the flat bottom surface. The lighting system further comprises a printed circuit board assembly comprising a printed circuit board mounted on the generally flat bottom section of the heat sink, one or more light emitting diodes (“LEDs”) mounted on the printed circuit board, one or more electrical devices configured to energize the LEDs, a plurality of wire connectors configured for electrically coupling power cables to the printed circuit board. The lighting system further comprises a lens mounted in the grooves of the heat sink, a first end cap coupled to one end of the elongated heat sink, and a second end cap coupled to the other end of the elongated heat sink, the one end opposite that of the other end.

In a first preferred embodiment, the back surface is generally parallel with the generally flat bottom surface of the internal cavity. The back surface is preferably generally parallel with the generally flat bottom surface of the internal cavity. The acute angle is preferably approximately 30 degrees. The lens preferably comprises a plurality of diffractive optical elements. The diffractive optical elements preferably comprise a diffractive grating having a periodicity in the range of approximately 10 micrometers to approximately 200 micrometers. The diffractive grating preferably comprises a plurality of triangularly-shaped ridges, each ridge having a first and a second grating surface, the first and the second grating surfaces slanted symmetrically opposite to each other, the first and second grating surfaces forming a predetermined angle, wherein the predetermined angle is in the range of approximately 50 degrees to approximately 120 degrees.

The diffractive grating preferably comprises a plurality of triangularly-shaped ridges, each ridge having a first and a second grating surface, the first and the second grating surfaces slanted asymmetrically opposite to each other, the first and second grating surface forming a predetermined angle, wherein the predetermined angle is in the range of approximately 80 degrees to approximately 150 degrees. The diffractive grating preferably comprises a plurality of curved ridges emerging from the body of the lenses, each ridge formed by a symmetrical arc having one center emerging from the body of the lenses characterized by a predetermined angle, wherein the predetermined angle is in the range of approximately 50 degrees to approximately 120 degrees.

The diffractive grating preferably comprises a plurality of curved ridges, each ridge having a first arced and a second arced grating surface, the first and the second grating surfaces slanted asymmetrically opposite to each other, the first and second grating surfaces emerging from the body of the lenses characterized by a predetermined angle, wherein the predetermined angle is in the range of approximately 80 degrees to approximately 150 degrees. The one or more electrical devices configured to energize the LEDs preferably further comprises a power supply configured to energize the plurality of LEDs using alternating current (“AC”) line current without employing a transformer.

In a second aspect, a lighting system is disclosed. The lighting system comprises an elongated heat sink, the heat sink having a back surface configured for mounting, the heat sink further comprising an internal cavity running along the length of the heat sink, the inner cavity having a generally flat bottom surface and two walls extending perpendicular from the generally flat bottom surface, each wall having a groove running along the length of the heat sink, each groove spaced equidistant from the flat bottom surface. The lighting system further comprises one or more light emitting diodes (“LEDs”) thermally mounted to the flat bottom surface, the LEDs mounted to emit light away from the flat bottom surface, and a lens mounted in the grooves of the heat sink.

In a second preferred embodiment, the lens comprises a diffractive grating having a periodicity in the range of approximately 10 micrometers to approximately 200 micrometers. The diffractive grating preferably comprises a plurality of triangularly-shaped ridges, each ridge having a first and a second grating surface, the first and the second grating surfaces slanted symmetrically opposite to each other, the first and second grating surface forming a predetermined angle, wherein the predetermined angle is in the range of approximately 50 degrees to approximately 120 degrees. The diffractive grating preferably comprises a plurality of triangularly-shaped ridges, each ridge having a first and a second grating surface, the first and the second grating surfaces slanted asymmetrically opposite to each other, the first and second grating surface forming a predetermined angle, wherein the predetermined angle is in the range of approximately 80 degrees to approximately 150 degrees.

The diffractive grating preferably comprises a plurality of curved ridges emerging from the body of the lenses, each ridge formed by a symmetrical arc having one center emerging from the body of the lenses characterized by a predetermined angle, wherein the predetermined angle is in the range of approximately 50 degrees to approximately 120 degrees. The diffractive grating preferably comprises a plurality of curved ridges, each ridge having a first arced and a second arced grating surface, the first and the second grating surfaces slanted asymmetrically opposite to each other, the first and second grating surfaces emerging from the body of the lenses characterized by a predetermined angle, wherein the predetermined angle is in the range of approximately 80 degrees to approximately 150 degrees.

In a third aspect, a lighting system is disclosed. The lighting system comprises an elongated heat sink, the heat sink having a back surface configured for mounting, the heat sink further comprising an internal cavity running along the length of the heat sink, the inner cavity having a generally flat bottom surface and two vertical walls, each vertical wall having a groove running along the length of the heat sink, each groove spaced equidistant from the flat bottom surface, and a lens mounted in the grooves of the heat sink.

In a third preferred embodiment, the back surface is generally parallel with the generally flat bottom surface of the internal cavity. The back surface preferably generally forms an acute angle with the generally flat bottom surface of the internal cavity.

These and other features and advantages of the invention will become more apparent with a description of preferred embodiments in reference to the associated drawings.

### DESCRIPTION OF THE DRAWINGS

FIG. 1 is a side, perspective view of an LED lighting system in one or more embodiments.

FIG. 2 is a side, perspective view of a partially disassembled LED lighting system.

FIG. 3 is a cross-sectional view of the heat sink.

FIG. 4 is a cross-sectional view of the heat sink with the lens and printed circuit board assembly.

FIG. 5 is a side, perspective view of the center section of the LED lighting system showing the connections to the power cord.

FIG. 6 is a side, perspective view of an LED lighting system having LEDs positioned at an angle with respect to the mounting surface in one or more embodiments.

FIG. 7 is a side, perspective view of a partially disassembled LED lighting system.

FIG. 8 is a cross-sectional view of the heat sink where the LEDs are positioned at an angle with respect to the mounting surface in one or more embodiments.

FIG. 9 is a cross-sectional view of the heat sink with the lens and printed circuit board assembly where the LEDs are positioned at an angle with respect to the mounting surface in one or more embodiments.

FIG. 10 is a front, perspective view of the center section of the LED lighting system showing the connections to the power cord.

FIG. 11 is a side, perspective view of an LED lighting system in one or more embodiments.

FIG. 12 is a side, perspective view of a partially disassembled LED lighting system.

FIG. 13 is a cross-sectional view of the heat sink.

FIG. 14 is a schematic representation of an LED lighting system illustrating light radiated from an LED, where the lens does not have diffractive optical elements.

FIG. 15 is a typical emission pattern of the lighting system depicted in FIG. 14.

FIG. 16 is a schematic representation of an LED lighting system illustrating light radiated from an LED through a lens, where the lens has symmetrical, saw-tooth ridges.

FIG. 17 is a schematic representation of an LED lighting system illustrating light radiated from an LED through a lens, where the lens has symmetrical, curved ridges.

FIG. 18 is a typical emission pattern of the lighting system depicted in FIG. 17.

FIG. 19 is a schematic representation of an LED lighting system illustrating light radiated from an LED through a lens, where the lens has asymmetrical, saw-tooth ridges.

FIG. 20 is a schematic representation of an LED lighting system illustrating light radiated from an LED through a lens, where the lens has asymmetrical, curved ridges.

FIG. 21 is a schematic electrical circuit diagram of the LED power source in one or more embodiments.

### DETAILED DESCRIPTION OF THE PREFERRED EMBODIMENTS

One or more embodiments are directed to LED display case fixtures capable of replacing inefficient fluorescent tubes in commercial freezer and display cases. The LED lighting systems may provide a versatile, modular solution for commercial cold case and retail display case lighting applications. Embodiments may offer reduced energy costs, higher quality lighting, reduced maintenance costs, and significantly better lumen maintenance over the service life.

Embodiments may exhibit up to 80% power savings over the commonly used fluorescent tube ballast combinations and, due to reduced heat generation, reduced strain and demand on refrigeration compressors and controls. Embodiments having AC current drivers eliminate the need for bulky external ballasts which may be the primary weakness of traditional lighting systems. Embodiments having a custom optical design assure the perfect light distribution for many applications.

One or more embodiments are directed to LED lighting fixtures having plano optics, heat sinks which dissipate heat directly, and linear AC direct current drivers. One or more embodiments employ integrated power converters on printed circuit boards having linear AC direct LED drivers, and micro optics lenses (i.e., plano optics) to change the direction of the emitted radiation. One or more embodiments offer a compact profile that saves space in many applications.

Conventional LED lighting fixtures often protrude from the ceiling and may require significant space. Moreover, many applications require a specific beam emission pattern and direction such as when illuminating products on the shelves. In an embodiment, the special design of the extruded heat sink enables direct heat dissipation. Specially designed plano optics uses minimum space and allows light to radiate at designated angles. The linear AC direct LED driver uses minimum components to save space.

One or more embodiments are directed to cabinet lighting or storage boxes which may need a special angle of lighting. One or more embodiments project light output uniformly, and have a unique lens designed to solve the problem of different beam direction requirements. Embodiments enable user to illuminate a desired location, and position.

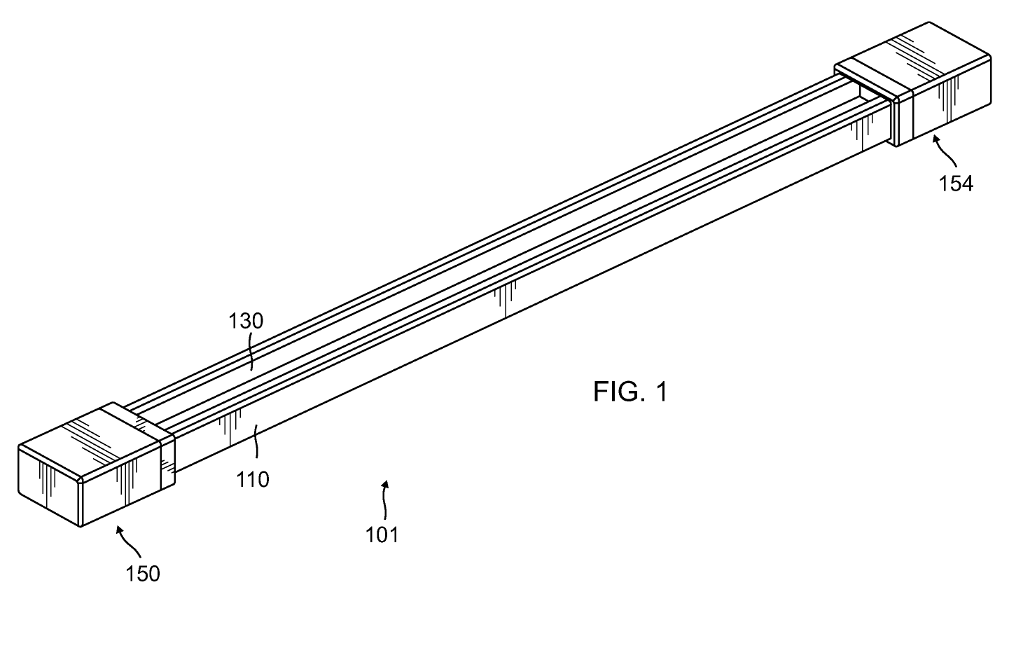

FIGS. 1-5 illustrate a lighting system 101 in one or more embodiments. As depicted in FIG. 1, the lighting system 101 comprises an elongated heat sink 110, a lens 130, a first end cap 150, and a second end cap 154. As used herein, heat sinks may refer to passive heat exchangers that cool devices by dissipating heat to the surrounding medium, and may be fabricated by various manufacturing techniques including extrusion. In one or more embodiments, heat sinks may be fabricated in aluminum, aluminum alloys, or other materials for example. In one or more embodiments, single, one-piece heat sinks are contemplated.

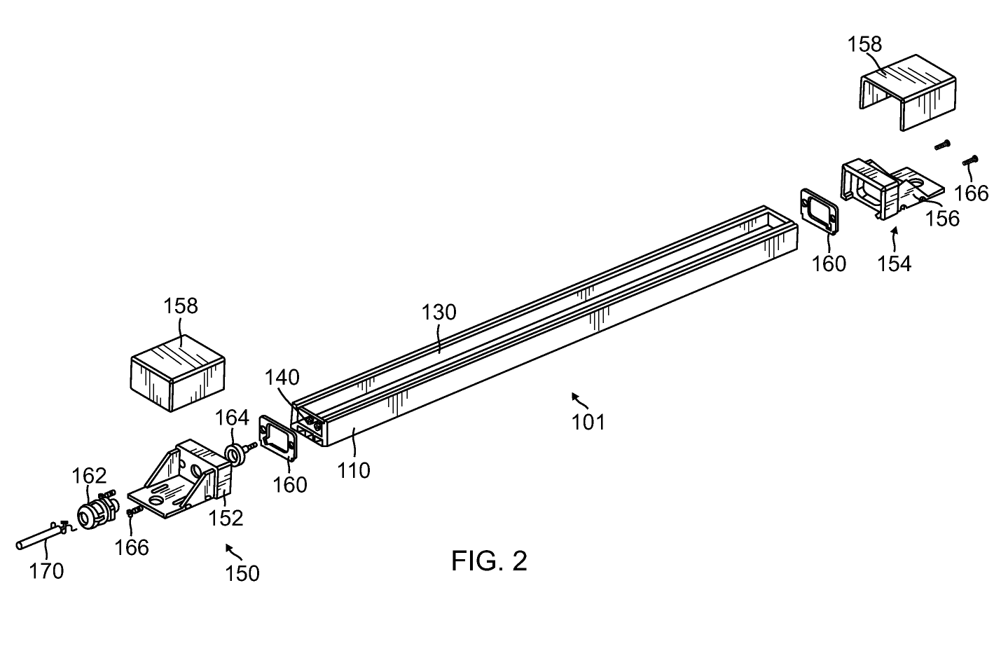

FIG. 2 illustrates a partially exploded view of the lighting system 101. The first end cap 150 has an end cap base 152 which attaches to the heat sink 110 through an end cap plate 160 with a plurality of screws 166. The end cap base 152 is configured to receive an electrical connector 162 which is held in place with the nut 164. The electrical connector 162 receives the power cord 170 which provides power to the LEDs. Housing 158 is placed over the end cap base 152.

The second end cap 154 has a second end cap base 156 which attaches to the heat sink 110 through an end cap plate 160 with a plurality of screws 166. Housing 158 is placed over the end cap base 156. A printed circuit board assembly 140 is placed in the heat sink 110.

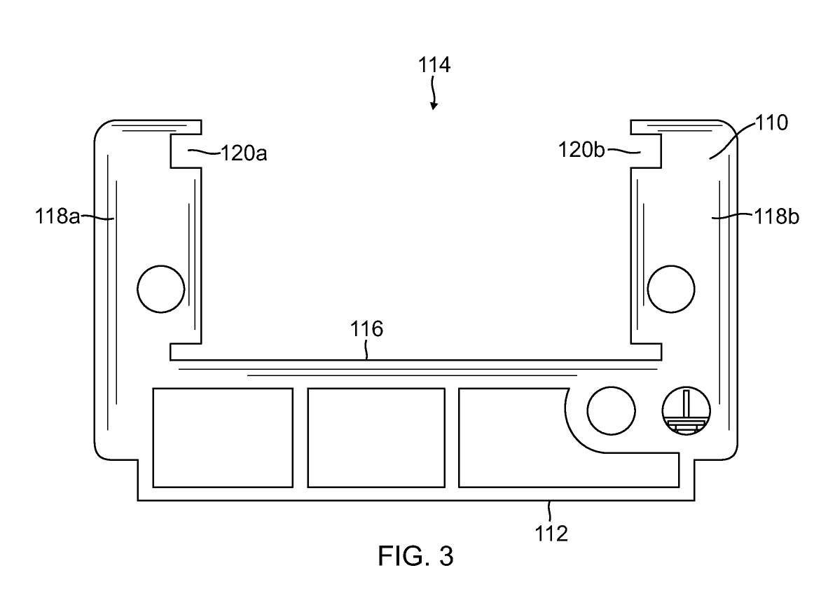

FIG. 3 is a side, cross-sectional view of the elongated heat sink 110. The heat sink has a back surface 112 configured for mounting and an internal cavity 114 running along the length of the heat sink 110. The inner cavity 114 has a generally flat bottom surface 116 and two walls 118a and 118b running perpendicular from the bottom surface 116. Each wall 118a and 118b has a groove 120a and 120b running along the length of the heat sink 110. Each of the grooves 120a and 120b are spaced equidistant from the flat bottom surface 116. The back surface 112 is generally parallel with the generally flat bottom surface 116 of the internal cavity 114.

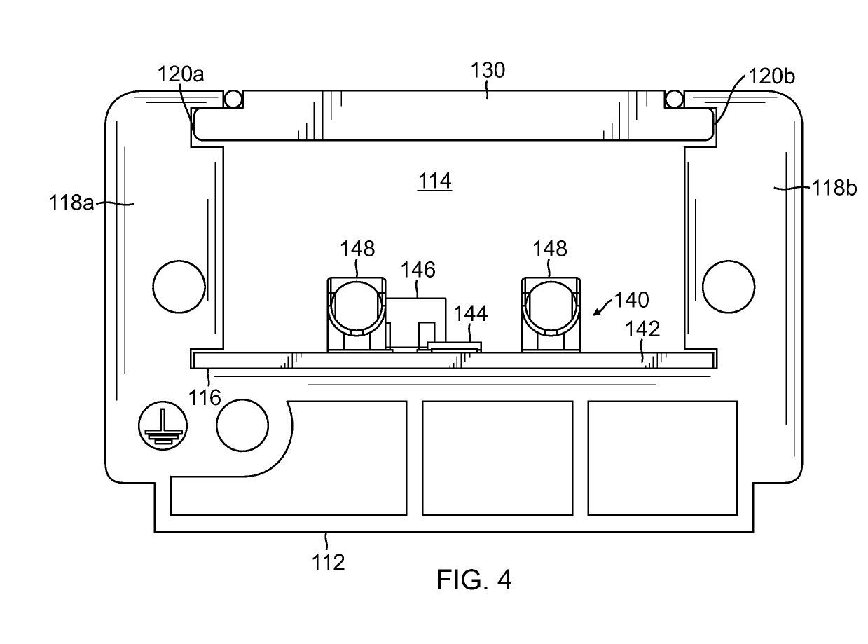

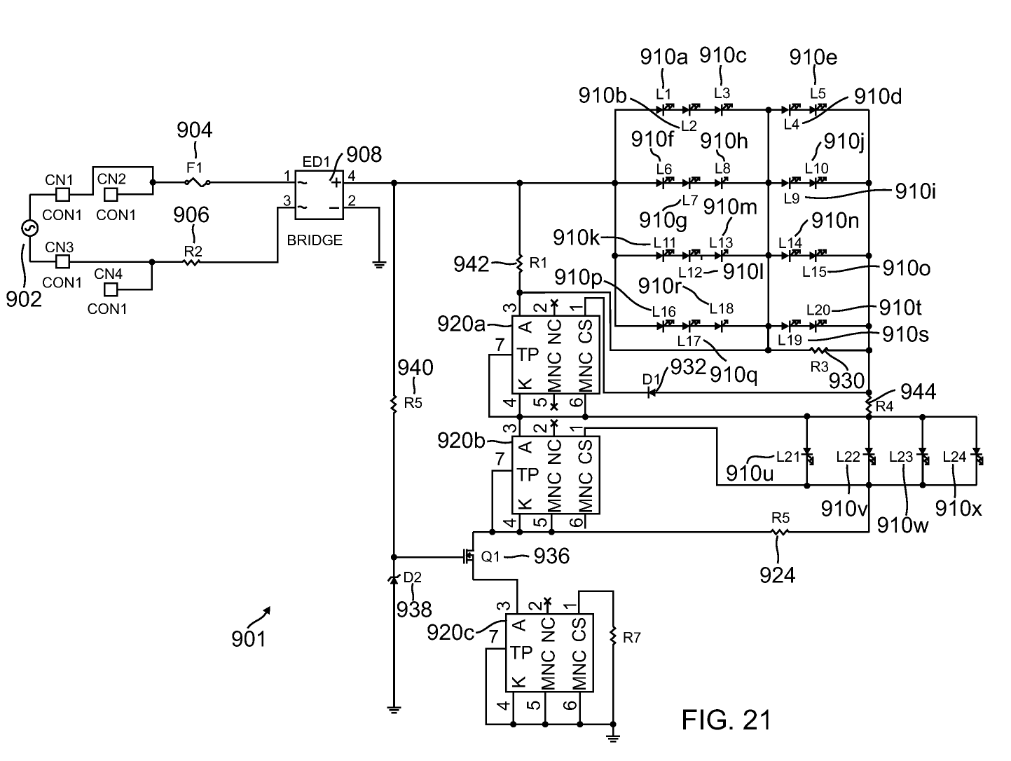

FIG. 4 is a cross-sectional view of the heat sink 110. The printed circuit board assembly 140 is placed in the heat sink 110. The printed circuit board assembly 140 comprises a printed circuit board 142 mounted on the generally flat bottom section 116, one or more light emitting diodes (“LEDs”) 144 mounted on the printed circuit board 142, one or more LED current drivers 146, and a plurality of wire connectors 148 configured for electrically coupling power cables 170 (see FIG. 2) to the printed circuit board 142. In one or more embodiments, the LED current drivers 146 may comprise one or more electrical devices or components, as discussed below and illustrated in FIG. 21. FIG. 4 also illustrates the lens 130 secured in the grooves 120a and 120b to the heat sink 110.

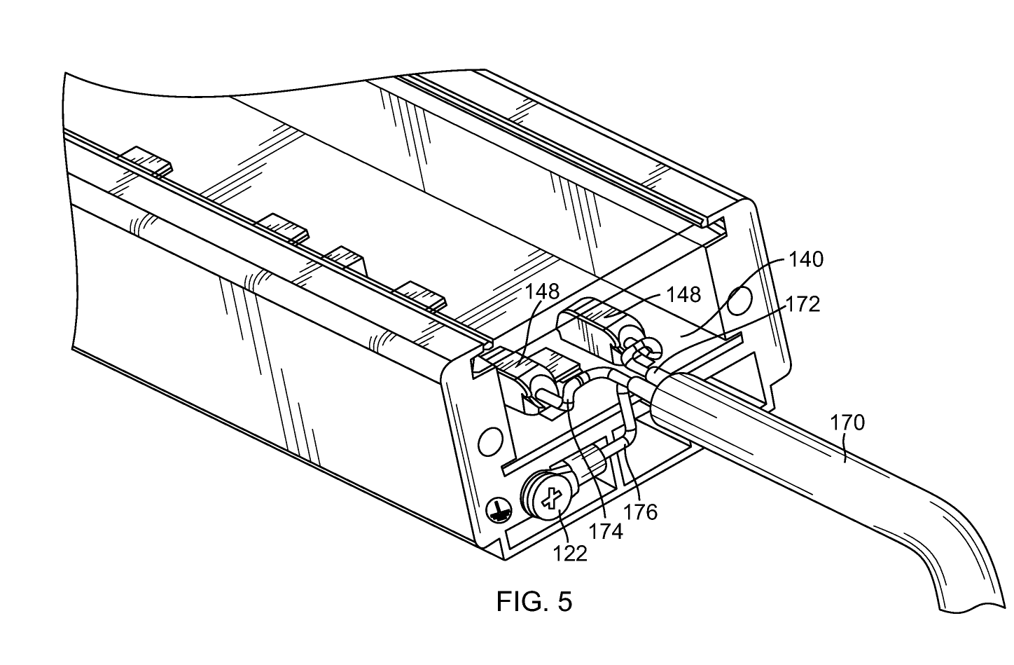

FIG. 5 illustrates the electrical connections of the power cord 170 to the printed circuit board assembly 140. In one or more embodiments, the power cord has a live or “hot” wire 172, a neutral wire 174, and a ground wire 176. The hot wire 172 and the neutral wire 174 are connected to respective wire connectors 148, and the ground wire 176 is connected to the ground tab 122.

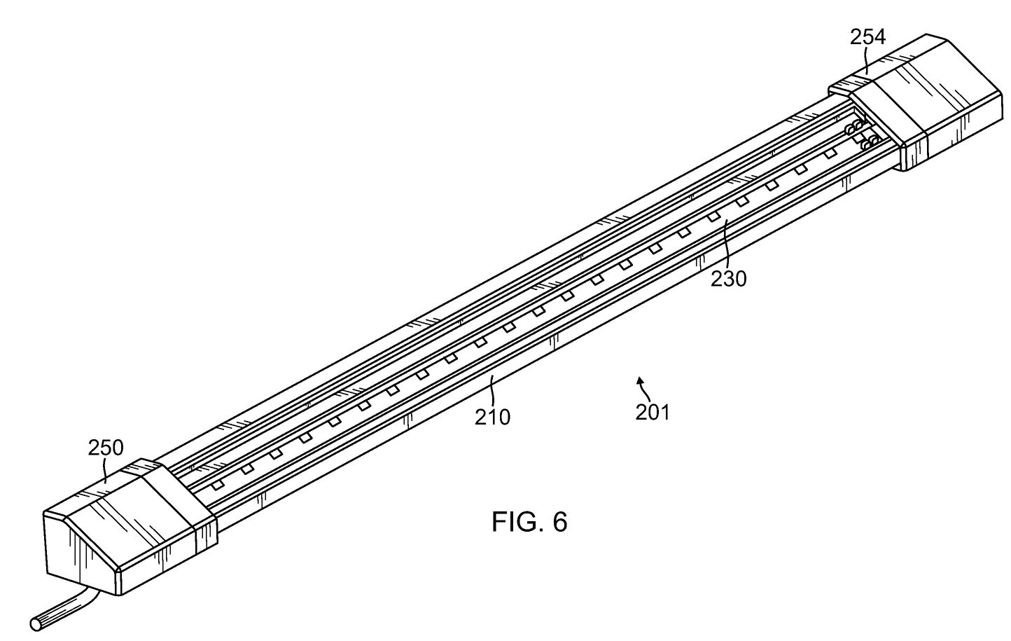

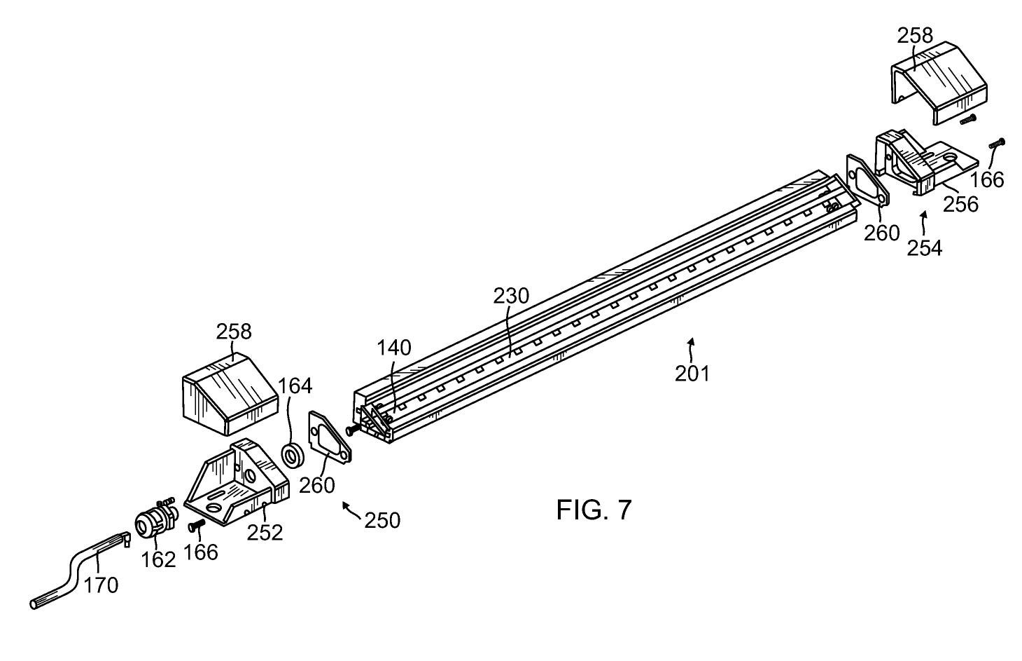

FIGS. 6-10 illustrate a lighting system 201 having LEDs positioned at an angle with respect to the mounting surface in one or more embodiments. As depicted in FIG. 6, the lighting system 201 comprises an elongated heat sink 210, a lens 230, a first end cap 250, and a second end cap 254. FIG. 7 illustrates a partially exploded view of the lighting system 201. The first end cap 250 has an end cap base 252 which attaches to the heat sink 210 through an end cap plate 260 with a plurality of screws 166. The end cap base 252 is configured to receive the electrical connector 162 which is held in place with the nut 160. The electrical connector 162 receives the power cord 170 which provides power to the LEDs. Housing 258 is placed over the end cap base 252.

The second end cap 254 has a second end cap base 256 which attaches to the heat sink 210 through an end cap plate 260 with a plurality of screws 166 Housing 258 is placed over the end cap base 256. A printed circuit board assembly 140 is placed in the heat sink 210.

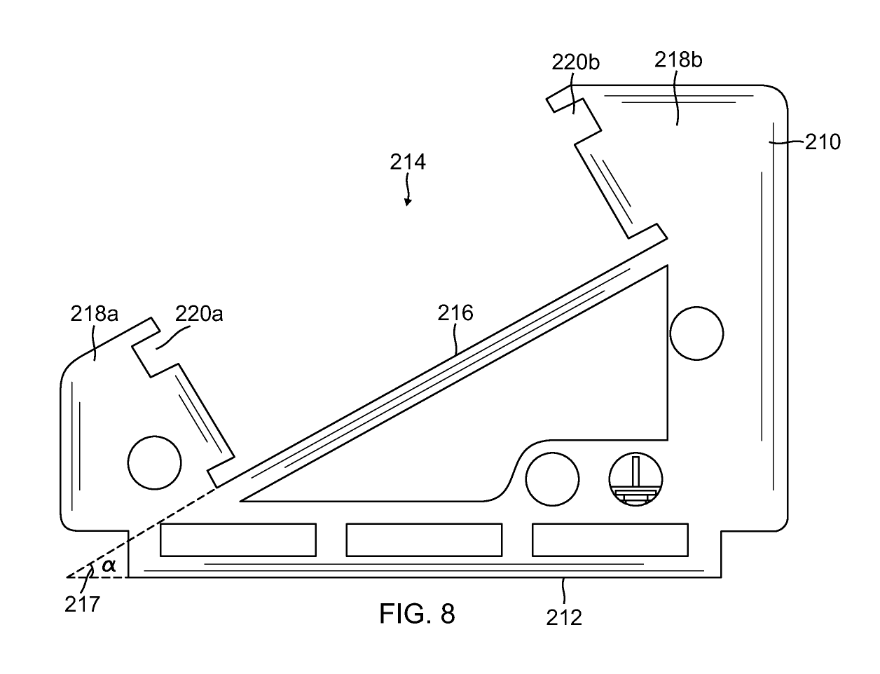

FIG. 8 is a side, cross-sectional view of the elongated heat sink 210. The heat sink has a back surface 212 configured for mounting the lighting system 201, and an internal cavity 214 running along the length of the heat sink 210. The inner cavity 214 has a generally flat bottom surface 216 and two walls 218a and 218b running perpendicular to the flat bottom surface. Each wall 218a and 218b has a groove 220a and 220b running along the length of the heat sink 210. Each of the grooves 220a and 220b are spaced equidistant from the flat bottom surface 216. The flat bottom surface 216 forms an acute angle α 217 with respect to the back surface 212. In one or more embodiments, the acute angle α 217 is approximately 30 degrees.

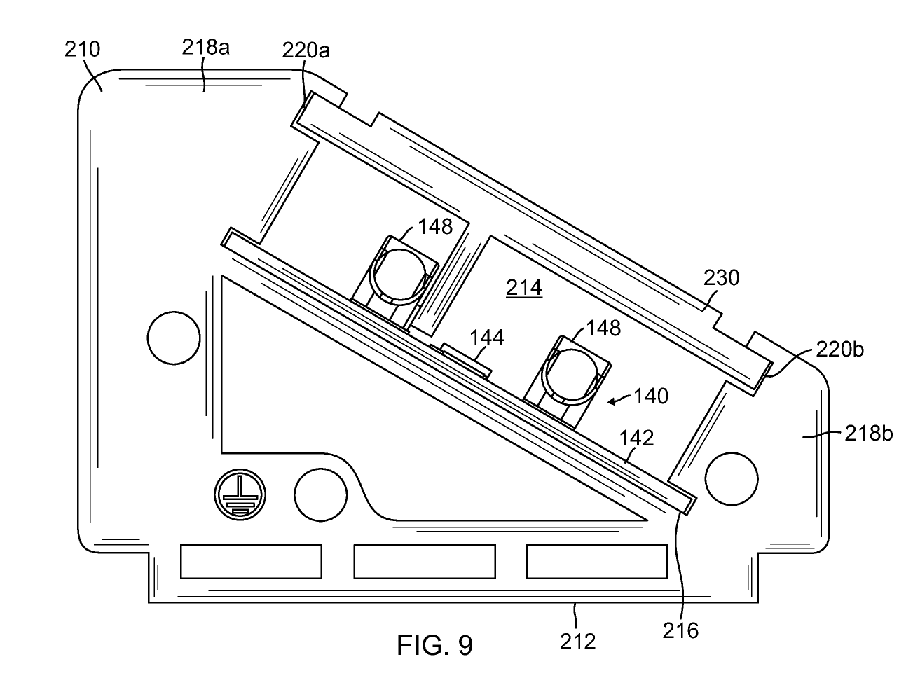

FIG. 9 is a cross-sectional view of the heat sink 210. The printed circuit board assembly 140 is placed in the heat sink 110. The printed circuit board assembly 140 comprises a printed circuit board 142 mounted on the generally flat bottom section 216, one or more light emitting diodes (“LEDs”) 144 mounted on the printed circuit board 142, one or more LED current drivers 146, and a plurality of wire connectors 148 configured for electrically coupling power cables 170 (see FIG. 2) to the printed circuit board 142. FIG. 9 also illustrates the lens 230 secured in the grooves 220a and 220b to the heat sink 310.

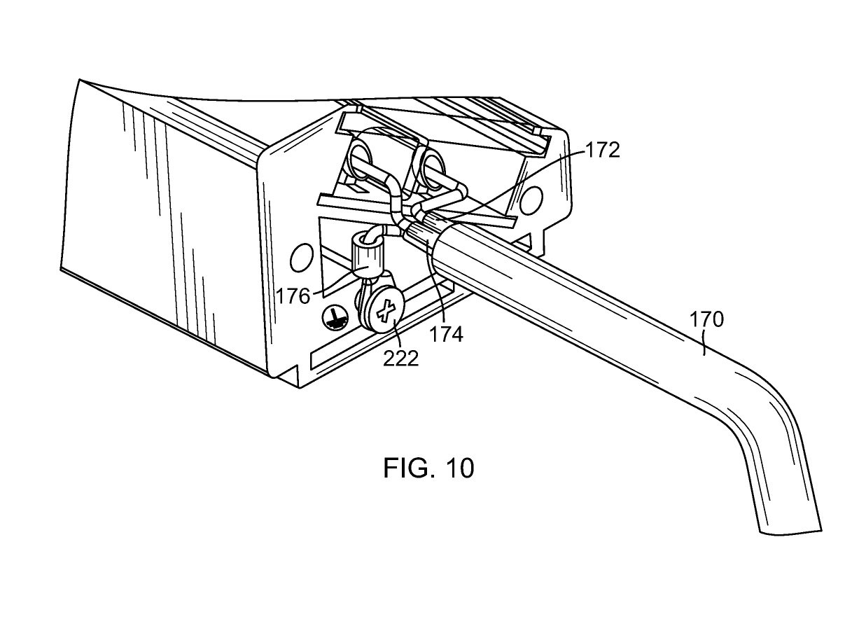

FIG. 10 illustrates the electrical connections of the power cord 170 to the printed circuit board assembly 140. In one or more embodiments, the power cord has a live or “hot” wire 172, a neutral wire 174, and a ground wire 176. The hot wire 172 and the neutral wire 174 are connected to respective wire connectors 148, and the ground wire 176 is connected to the ground tab 222.

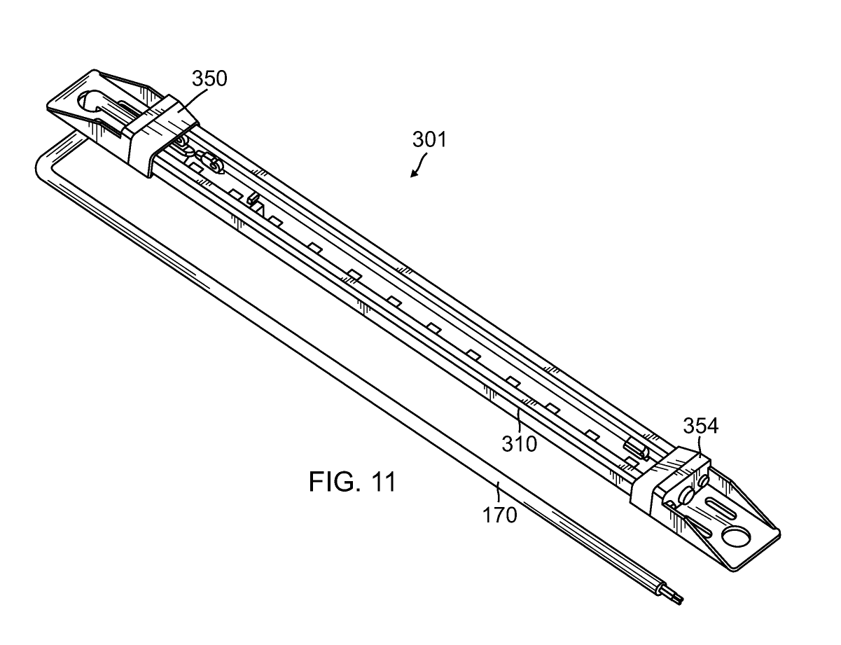

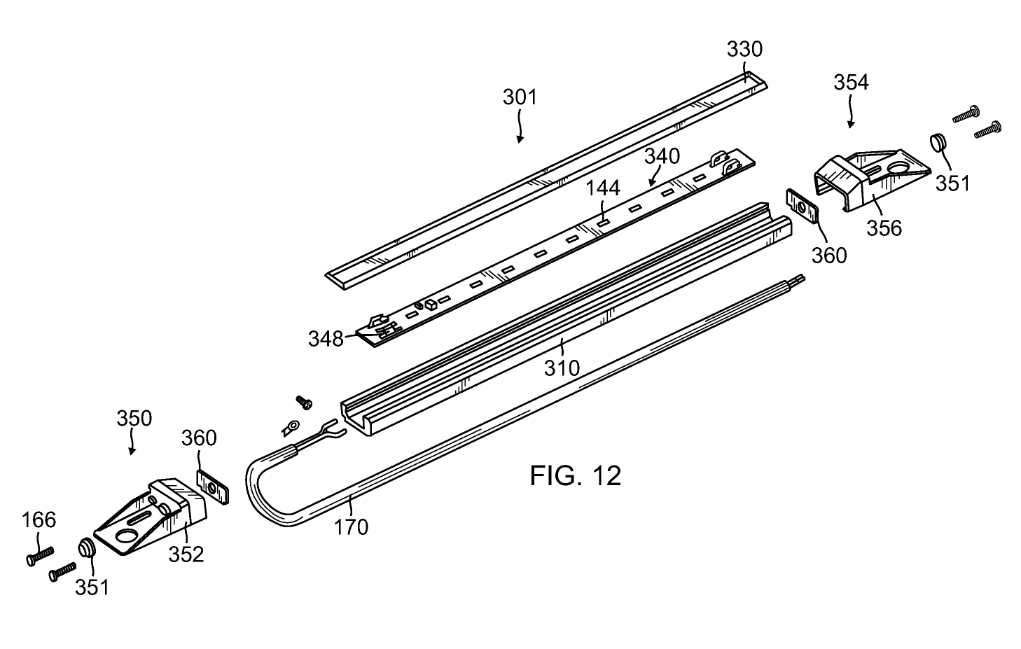

FIGS. 11-13 illustrate a lighting system 301 having LEDs in one or more embodiments. As depicted in FIG. 11, the lighting system 301 comprises an elongated heat sink 310, a lens 330, a first end cap 350, and a second end cap 354. FIG. 12 illustrates a partially exploded view of the lighting system 301. The first end cap 350 has an end cap base 352 which attaches to the heat sink 310 through an end cap plate 360 with a plurality of screws 166. The second end cap 354 has a second end cap base 356 which attaches to the heat sink 310 through an end cap plate 360 with a plurality of screws 166. A printed circuit board assembly 340 is placed in the heat sink 210. The printed circuit board assembly 340 comprises a printed circuit board mounted on the generally flat bottom section 316, one or more light emitting diodes (“LEDs”) 144 mounted on the printed circuit board, one or more LED current drivers, and a plurality of wire connectors 348 configured for electrically coupling power cables 170 (see FIG. 2) to the printed circuit board 142.

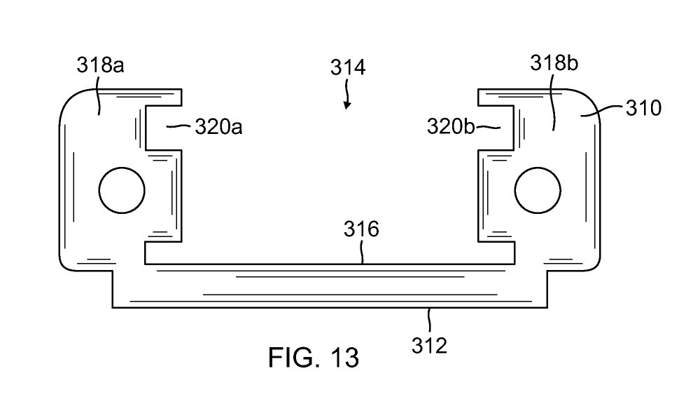

FIG. 13 is a side, cross-sectional view of the elongated heat sink 310. The heat sink 310 has a back surface 312 configured for mounting the lighting system 301, and an internal cavity 314 running along the length of the heat sink 310. The inner cavity 314 has a generally flat bottom surface 316 and two walls 318a and 318b running perpendicular to the flat bottom surface 316. Each wall 318a and 318b has a groove 320a and 320b running along the length of the heat sink 310. Each of the grooves 320a and 320b are spaced equidistant from the flat bottom surface 316. The flat bottom surface 316 is parallel with the back surface 312.

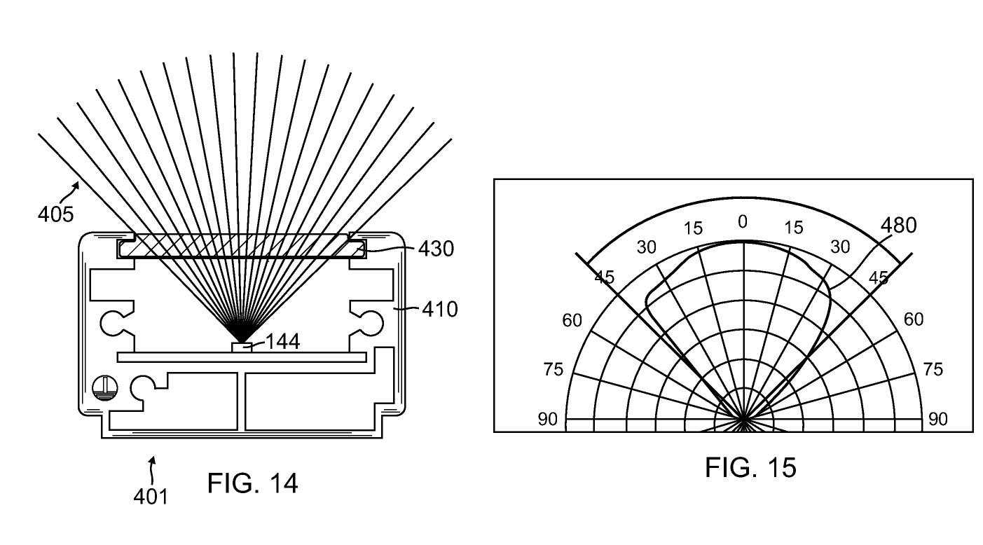

FIG. 14 is a schematic representation of a lighting system 401 having a heat sink 410, an LED 144, and a flat lens 430 having no diffractive optical elements. The light 405 radiating from the LED 144 passes through the flat lens 430, and illuminates the surroundings. FIG. 15 is a typical emission pattern 480 of the LED 144 and the flat lens 430 without diffractive optical elements. In this configuration, the light 405 radiates between approximately −45 degrees to approximately +45 degrees with respect to the normal of the lens 430.

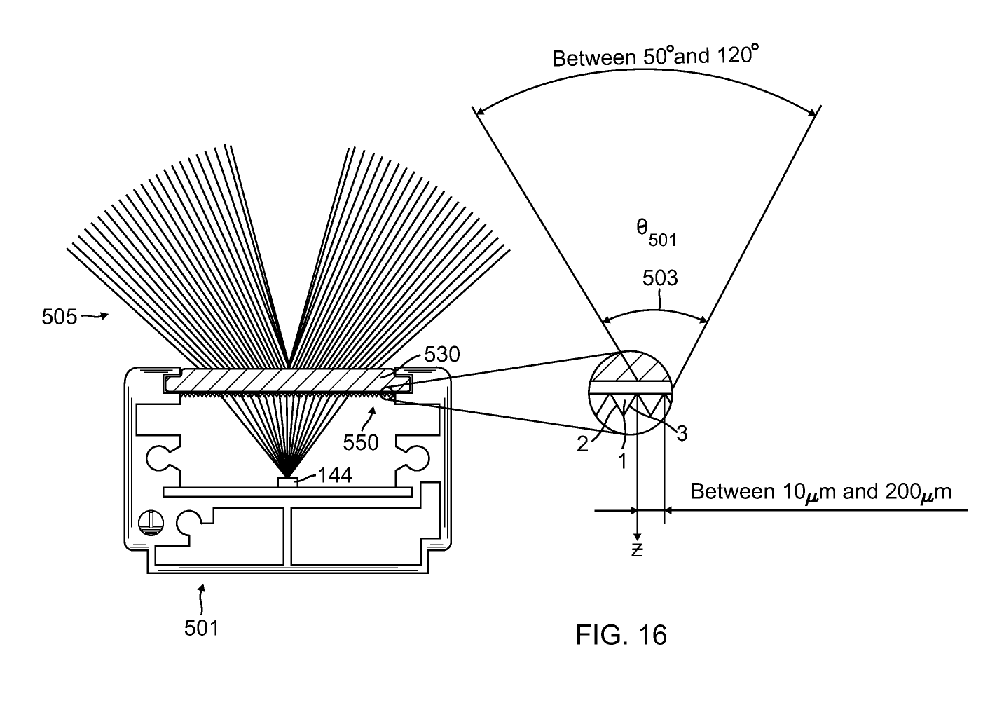

FIGS. 16-20 are schematic representations of light systems employing lenses having diffractive optical elements. FIG. 16 depicts a lighting system 501 employing diffractive optical elements on the bottom surface of the lens 530, where the diffractive optical elements comprise a plurality of triangularly-shaped ridges 1 formed by a first surface 2 and a second surface 3. The first surface 2 and the second surface 3 are slanted symmetrically opposite to each other with respect to the normal of the lens 530, depicted by the Z-axis. The periodicity of the ridges is in the range of approximately 10 micrometers to 200 micrometers. The intersection of the first surface 2 and the second surface 3 forms a predetermined angle θ₅₀₁ 503, wherein the predetermined angle θ₅₀₁ 503 is in the range of approximately 50 degrees to approximately 120 degrees in one or more embodiments.

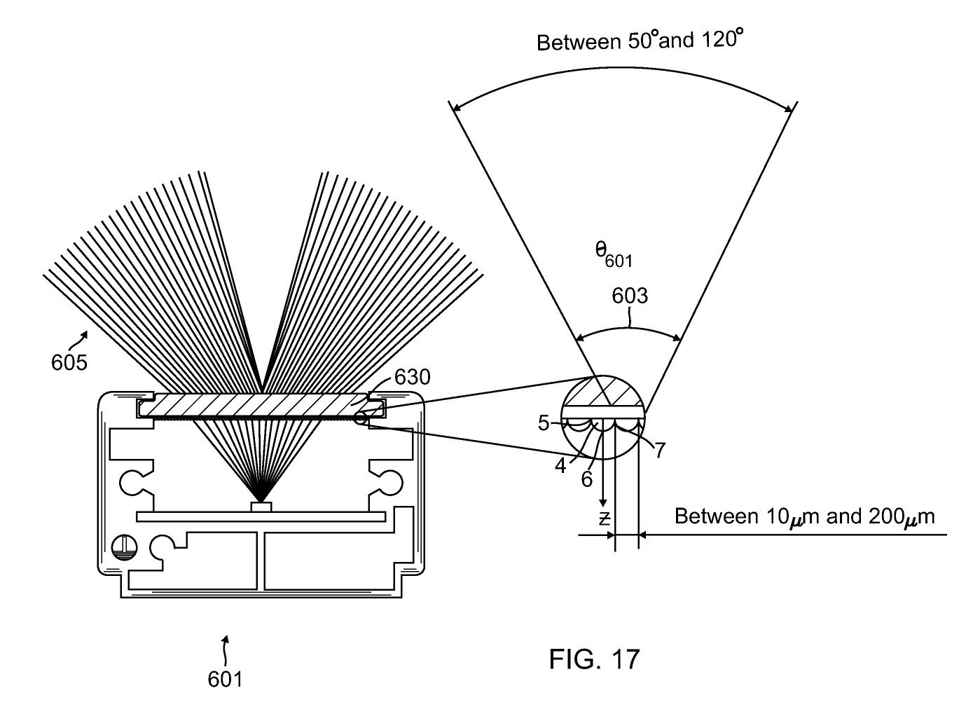

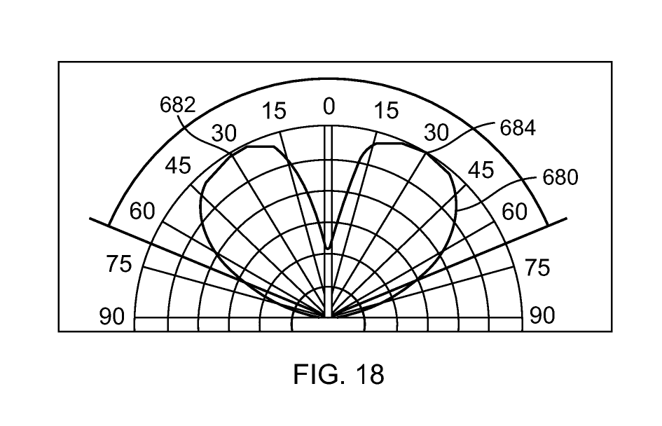

FIG. 17 depicts a lighting system 601 employing diffractive optical elements on the bottom surface of the lens 630, where the diffractive optical elements comprise a plurality of curved ridges 4 having a periodicity in the range of approximately 10 micrometers to 200 micrometers. The ridges 4 are symmetrical and emerge from the body of the lens 630 at point 5, extend to the distal point 6 which coincides with the center normal of the ridge depicted by the z-axis, and curves back to the body of the lens 630 to point 7. The ridge 4 is a symmetrical arc having one center. The ridge 4 emerges from the body of the lens 630 having a difference in slope in the range of approximately 50 degrees to approximately 120 degrees. FIG. 18 is a typical emission pattern 680 of the lighting system 601. In this configuration, the light 605 radiates having a first lobe 602 centered at approximately −30 degrees and a second lobe 684 centered at approximately +30 degrees.

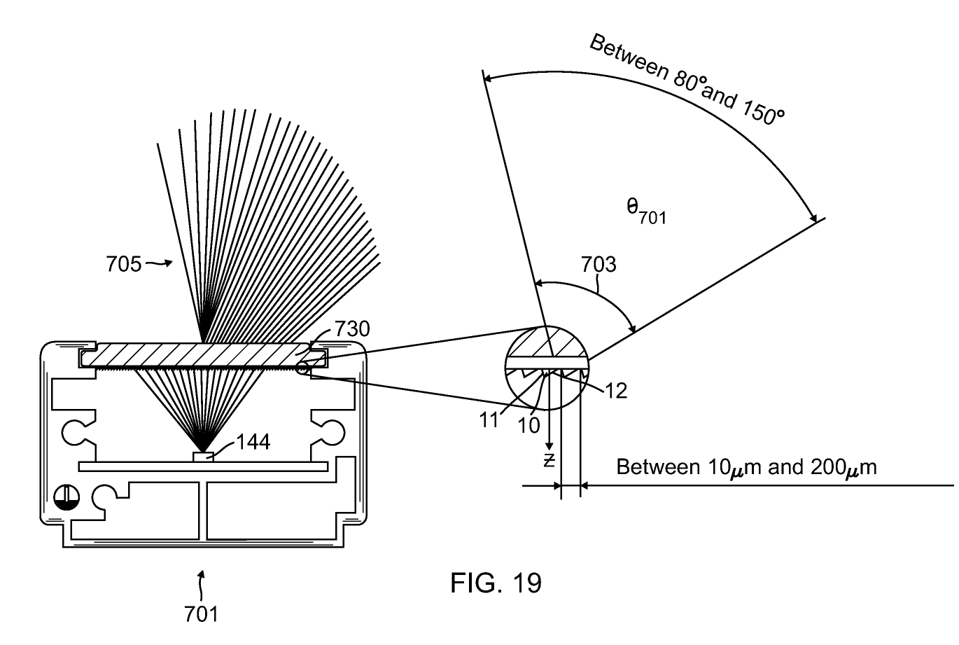

FIG. 19 depicts a lighting system 701 employing diffractive optical elements on the bottom surface of the lens 730, where the diffractive optical elements comprise a plurality of asymmetrical, triangular shaped ridges 10 formed by a first surface 11 and a second surface 12. The first surface 11 and the second surface 12 are slanted asymmetrically opposite to each other with respect to the normal of the lens 730, depicted by the Z-axis. The periodicity of the ridges 10 is in the range of approximately 10 micrometers to 200 micrometers. The intersection of the first surface 11 and the second surface 12 forms a predetermined angle θ₇₀₁ 703, wherein the predetermined angle θ₇₀₁ 703 is in the range of approximately 80 degrees to approximately 150 degrees in one or more embodiments.

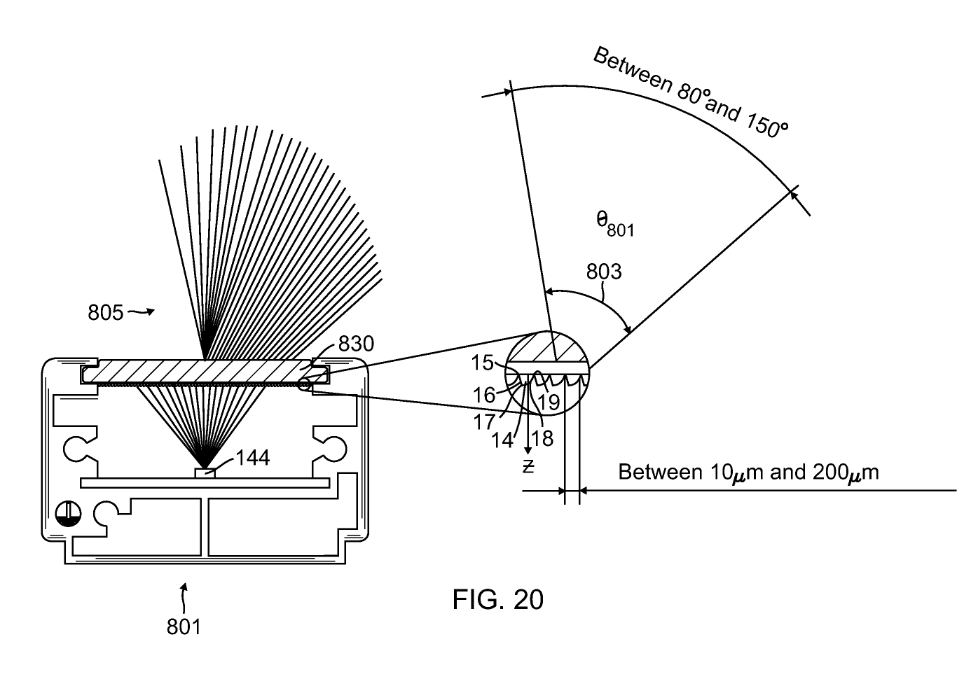

FIG. 20 depicts a lighting system 801 employing diffractive optical elements on the bottom surface of the lens 830, where the diffractive optical elements comprise a plurality of asymmetrical, arc shaped ridges 14 formed by a first surface 16 and a second surface 18. The first surface 16 and the second surface 18 are slanted asymmetrically opposite to each other with respect to the normal of the lens 830, depicted by the Z-axis. The ridges 14 are asymmetrical and emerge from the body of the lens 830 at point 15, extend to the distal point 17 which is offset with respect to the center normal of the ridge depicted by the z-axis, and curves back to the body of the lens 830 to point 19. Ridge 14 has two asymmetrical arcs. The ridge 14 emerges from the body of the lens 830 having a difference in slope in the range of approximately 80 degrees to approximately 150 degrees. The periodicity of the ridges 14 is in the range of approximately 10 micrometers to 200 micrometers. The intersection of the first surface 16 and the second surface 18 forms a predetermined angle θ₈₀₁ 803, wherein the predetermined angle θ₈₀₁ 803 is in the range of approximately 80 degrees to approximately 150 degrees in one or more embodiments.

FIG. 21 is a schematic diagram of the electrical circuit 901 for energizing LEDs 910a-910x. An AC power source 902 is connected to a bridge rectifier 908 through fuse 904 and resistor 906. Pin 2 of the bridge 908 is connected to ground, and pin 4 of the bridge 908 is connected to a drive circuit employing a stack of Three-Terminal Current Controllers (“TTCC”) 920a, 920b, and 920c. The TTCC 920a-920c is configured in parallel with the LED strings. Pin 4 of the bridge 908 is connected to LEDs 910a, 910b, and 910c, in parallel with LEDs 910f, 910g, and 910h, in parallel with LEDs 910k, 9101, and 910m, in parallel with LEDs 910p, 910q, and 910r. LEDs 910d and 910e, are in parallel with LEDs 910i and 910j, in parallel with 910n and 910o, in parallel with LEDs 910s and 910t, and in parallel with resistor 930. The cathodes of LEDs 910c, 910h, 910m, and 910r are connected to the anodes of LEDs 910d, 910i, 910s, and resistor 930. Pin 4 of the bridge 908 is also connected to resistor 940, which leads to ground via diode 938 and is employed to bias transistor 936. Pin 4 of bridge 908 is also connected to resistor 942, which in turn leads to pin 3 of TTCC 940a as well as diode 932. Pin 4 of TTCC 920a is connected to pin 3 of TTCC 920b, as well as to a parallel combination of LEDs 910u, 910v, 910w, and 910x. Pins 4, 5, and 6 of TTCC 920b are connected to transistor 936, as well as resistor 924 which act as a path to LEDs 910u, 910v, 910w, and 910x. Transistor 936 is also connected to pin 3 of TTCC 920c.

Although the invention has been discussed with reference to specific embodiments, it is apparent and should be understood that the concept can be otherwise embodied to achieve the advantages discussed. The preferred embodiments above have been described primarily as LED lighting systems. In this regard, the foregoing description of the LED lighting systems are presented for purposes of illustration and description.

Furthermore, the description is not intended to limit the invention to the form disclosed herein. Accordingly, variants and modifications consistent with the following teachings, skill, and knowledge of the relevant art, are within the scope of the present invention. The embodiments described herein are further intended to explain modes known for practicing the invention disclosed herewith and to enable others skilled in the art to utilize the invention in equivalent, or alternative embodiments and with various modifications considered necessary by the particular applications or uses of the present invention.

What is claimed is:

1. A lighting system comprising:
an elongated heat sink, the heat sink having a back surface configured for mounting, the heat sink further comprising an internal cavity running along the length of the heat sink, the inner cavity having a generally flat bottom surface and two walls extending perpendicular from the generally flat bottom surface, each wall having a groove running along the length of the heat sink, each groove spaced equidistant from the flat bottom surface;
a printed circuit board assembly comprising:
a printed circuit board mounted on the generally flat bottom section of the heat sink;
one or more light emitting diodes (“LEDs”) mounted on the printed circuit board;
one or more electrical devices configured to energize the LEDs;
a plurality of wire connectors configured for electrically coupling power cables to the printed circuit board
a lens mounted in the grooves of the heat sink;
a first end cap coupled to one end of the elongated heat sink; and,
a second end cap coupled to the other end of the elongated heat sink, the one end opposite that of the other end.

2. The lighting system of claim 1, wherein the back surface is generally parallel with the generally flat bottom surface of the internal cavity.

3. The lighting system of claim 1, wherein the back surface generally forms an acute angle with the generally flat bottom surface of the internal cavity.

4. The lighting system of claim 1, wherein the acute angle is approximately 30 degrees.

5. The lighting system of claim 1, wherein the lens comprises a plurality of diffractive optical elements.

6. The lighting system of claim 1, wherein the diffractive optical elements comprise a diffractive grating having a periodicity in the range of approximately 10 micrometers to approximately 200 micrometers.

7. The lighting system of claim 6, wherein the diffractive grating comprises a plurality of triangularly-shaped ridges, each ridge having a first and a second grating surface, the first and the second grating surfaces slanted symmetrically opposite to each other, the first and second grating surfaces forming a predetermined angle, wherein the predetermined angle is in the range of approximately 50 degrees to approximately 120 degrees.

8. The lighting system of claim 6, wherein the diffractive grating comprises a plurality of triangularly-shaped ridges, each ridge having a first and a second grating surface, the first and the second grating surfaces slanted asymmetrically opposite to each other, the first and second grating surface forming a predetermined angle, wherein the predetermined angle is in the range of approximately 80 degrees to approximately 150 degrees.

9. The lighting system of claim 6, wherein the diffractive grating comprises a plurality of curved ridges emerging from the body of the lenses, each ridge formed by a symmetrical arc having one center emerging from the body of the lenses characterized by a predetermined angle, wherein the predetermined angle is in the range of approximately 50 degrees to approximately 120 degrees.

10. The lighting system of claim 6, wherein the diffractive grating comprises a plurality of curved ridges, each ridge having a first arced and a second arced grating surface, the first and the second grating surfaces slanted asymmetrically opposite to each other, the first and second grating surfaces emerging from the body of the lenses characterized by a predetermined angle, wherein the predetermined angle is in the range of approximately 80 degrees to approximately 150 degrees.

11. The lighting system of claim 1, wherein the one or more electrical devices configured to energize the LEDs further comprising a power supply configured to energize the plurality of LEDs using alternating current (“AC”) line current without employing a transformer.

12. A lighting system comprising:
an elongated heat sink, the heat sink having a back surface configured for mounting, the heat sink further comprising an internal cavity running along the length of the heat sink, the inner cavity having a generally flat bottom surface and two walls extending perpendicular from the generally flat bottom surface, each wall having a groove running along the length of the heat sink, each groove spaced equidistant from the flat bottom surface;
one or more light emitting diodes (“LEDs”) thermally mounted to the flat bottom surface, the LEDs mounted to emit light away from the flat bottom surface;
a lens mounted in the grooves of the heat sink.

13. The lighting system of claim 12, wherein the lens comprising a diffractive grating having a periodicity in the range of approximately 10 micrometers to approximately 200 micrometers.

14. The lighting system of claim 13, wherein the diffractive grating comprises a plurality of triangularly-shaped ridges, each ridge having a first and a second grating surface, the first and the second grating surfaces slanted symmetrically opposite to each other, the first and second grating surface forming a predetermined angle, wherein the predetermined angle is in the range of approximately 50 degrees to approximately 120 degrees.

15. The lighting system of claim 13, wherein the diffractive grating comprises a plurality of triangularly-shaped ridges, each ridge having a first and a second grating surface, the first and the second grating surfaces slanted asymmetrically opposite to each other, the first and second grating surface forming a predetermined angle, wherein the predetermined angle is in the range of approximately 80 degrees to approximately 150 degrees.

16. The lighting system of claim 13, wherein the diffractive grating comprises a plurality of curved ridges emerging from the body of the lenses, each ridge formed by a symmetrical arc having one center emerging from the body of the lenses characterized by a predetermined angle, wherein the predetermined angle is in the range of approximately 50 degrees to approximately 120 degrees.

17. The lighting system of claim 13, wherein the diffractive grating comprises a plurality of curved ridges, each ridge having a first arced and a second arced grating surface, the first and the second grating surfaces slanted asymmetrically opposite to each other, the first and second grating surfaces emerging from the body of the lenses characterized by a predetermined angle, wherein the predetermined angle is in the range of approximately 80 degrees to approximately 150 degrees.

18. A lighting system comprising:
an elongated heat sink, the heat sink having a back surface configured for mounting, the heat sink further comprising an internal cavity running along the length of the heat sink, the inner cavity having a generally flat bottom surface and two vertical walls, each vertical wall having a groove running along the length of the heat sink, each groove spaced equidistant from the flat bottom surface; and,
a lens mounted in the grooves of the heat sink.

19. The lighting system of claim 18, wherein the back surface is generally parallel with the generally flat bottom surface of the internal cavity.

20. The lighting system of claim 18, wherein the back surface generally forms an acute angle with the generally flat bottom surface of the internal cavity.
